(19) United States
(12) Patent Application Publication
(10) Pub. No.: US 2010/0005252 A1
(43) Pub. Date: Jan. 7, 2010

(54) STORAGE CONTROL SYSTEM

(75) Inventors: JIAN-FENG GUO, Shenzhen City (CN); AI-TING ZHANG, Shenzhen City (CN)

Correspondence Address: PCE INDUSTRY, INC.;ATT. Steven Reiss, 288 SOUTH MAYO AVENUE, CITY OF INDUSTRY, CA, 91789, US

(73) Assignees: HONG FU JIN PRECISION INDUSTRY (SHENZHEN) CO., LTD., Shenzhen City (CN); HON HAI PRECISION INDUSTRY CO., LTD., Tu-Cheng (TW)

(21) Appl. No.: 12/334,721

(22) Filed: Dec. 15, 2008

(30) Foreign Application Priority Data
Jul. 3, 2008 (CN) 200810302520.2

(51) Int. Cl. G06F 12/00

(52) U.S. Cl. 711/154; 711/E12.001

(57) ABSTRACT

A storage control system includes a storage device and a UPS electrically connected to and communicating with the storage device. The storage device has a write back process and a write through process for writing data into the storage device, and includes a monitoring module. The UPS includes a control chip. The control chip of the UPS sends state signals to the storage device. The monitoring module receives the state signals and selects one of the write back process and the write through process to replace the other one of the write back process and the write through process for writing data into the storage device, depending on the state signals.

### BACKGROUND

1. Technical Field

The present disclosure relates to a storage control system configured for writing data into a storage device.

2. Description of the Related Art

Usually, a typical storage device like a hard disk drive includes a cache and a disk for storing data. There are two processes, write back and write through, to write data into the typical storage device. In the write back process, the data is first written into the cache of the typical storage device, and then the data stored in the cache is written to the disk of the typical storage device when the volume of data stored in the cache is equal to a predetermined volume defined by the typical storage device. In the write through process, the data is written into the cache and the disk of the typical storage device at the same time. However, data writing velocity is faster in the write back process than the write through process, but data writing security in the write back process is lower than the write through process.

Therefore, there is room for improvement within the art.

### BRIEF DESCRIPTION OF THE DRAWINGS

FIG. 1 is a block diagram of an embodiment of a storage control system.

FIG. 2 is a flow chart illustrating an embodiment of a method using the storage control system of FIG. 1.

### DETAILED DESCRIPTION OF THE EMBODIMENTS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

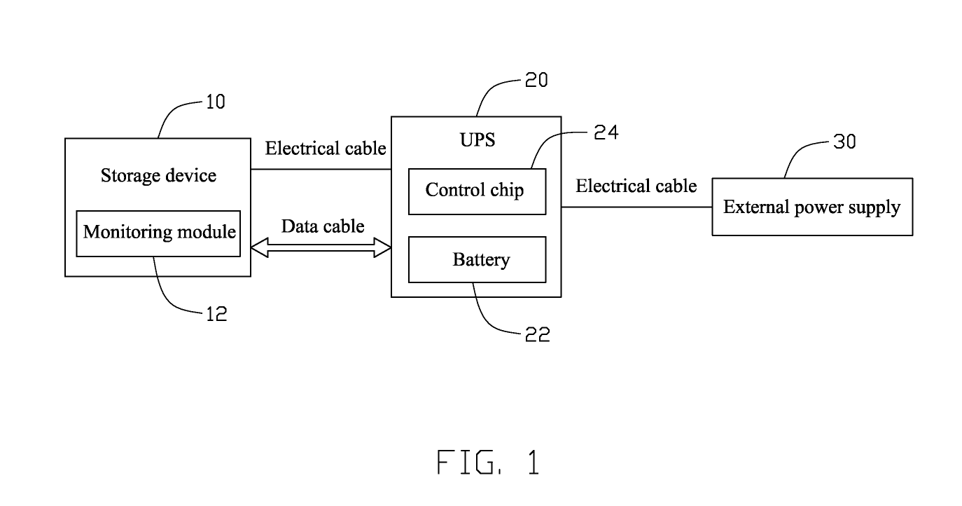

Referring to FIG. 1, an embodiment of a storage control system includes a storage device 10, an uninterruptible power supply (UPS) 20, and an external power supply 30. The storage device 10 is electrically connected to the UPS 20 with electrical cables, and communicates with the UPS 20 by data cables, such as serial cables or network cables. The UPS 20 is used to provide power to the storage device 10 via the electrical cable. The power supply 30 is electrically connected to the UPS 20, and provides power to the storage device 10 via the UPS 20.

The UPS 20 includes a rechargeable battery 22 charged by the power supply 30, and a control chip 24 for managing the UPS 20. Predetermined parameters of the battery 22, such as an output current, an output voltage, a capacity of the battery, and so on, are defined in the control chip 24. The control chip 24 is configured to detect states of whether the power supply 30 is providing power to the storage device 10 via the UPS 20, or a current parameter of the battery 22 of the UPS 20 is lower than a predetermined parameter, and to send corresponding state signals to the storage device 10 via the data cables.

The storage device 10 has two processes of writing data into the storage device 10, write back and write through, and includes a monitoring module 12. The monitoring module 12 is configured to receive the state signals sent by the control chip 24 of the UPS 20, and select one of the write back process and the write through process to replace the other one of the write back process and the write through process for writing data into the storage device 10.

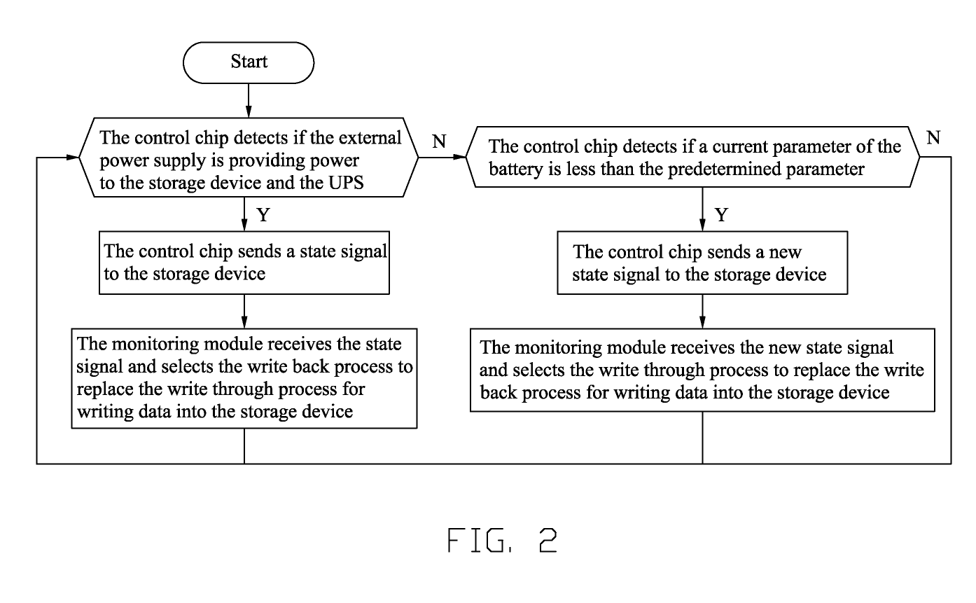

Referring also to FIG. 2, the control chip 24 of the UPS 20 detects if the power supply 30 is providing power to the UPS 20 and the storage device 10. If the power supply 30 is providing power to the UPS 20 and the storage device 10, the control chip 24 of the UPS 20 sends a corresponding state signal to the storage device 10. The monitoring module 12 of the storage device 10 receives the state signal, and selects the write back process to replace the write through process for writing data into the storage device 10. If the power supply 30 is not providing power to the UPS 20 and the storage device 10, the control chip 24 detects if a current parameter of the battery 22 is less than the predetermined parameter. If the current parameter of the battery 22 is less than the predetermined parameter, the control chip 24 of the UPS 20 sends a new state signal to the storage device 10. The monitoring module 12 of the storage device 10 receives the new state signal, and selects the write through process to replace the write back process for writing data into the storage device 10. If the current parameter of the battery 22 is not less than the predetermined parameter, the control chip 24 detects if the power supply 30 is providing power to the UPS 20 and the storage device 10.

In the illustrated embodiment, the write back process and the write through process are selectable by the monitoring module 12 depending on the state signals sent by the control chip 24 of UPS 20, thereby improving efficiency and security of writing the data into the storage device 10.

It is to be understood, however, that even though numerous characteristics and advantages have been set forth in the present disclosure, together with details of the structures and functions of the embodiments, the disclosure is illustrative only, and changes may be made in detail, especially in matters of shape, size, and arrangement of parts within the principles of the disclosure to the full extent indicated by the broad general meaning of the terms in which the appended claims are expressed.

What is claimed is:

1. A storage control system, comprising:
a storage device having a write back process and a write through process for writing data into the storage device, and comprising a monitoring module; and
an uninterruptible power supply (UPS) electrically connected to and communicating with the storage device, the UPS comprising a control chip, wherein the control chip of the UPS sends state signals to the storage device; the monitoring module receives the state signals and selects one of the write back process and the write through process to replace the other one of the write back process and the write through process for writing data into the storage device, depending on the state signals.

2. The storage control system of claim 1, further comprising an external power supply electrically connected to the UPS, wherein the power supply provides power to the storage device and the UPS.

3. The storage control system of claim 2, wherein the UPS further comprises a rechargeable battery; the power supply provides power to the battery; the battery provides power to the storage when the power supply is not providing power to the storage device.

4. The storage control system of claim 3, wherein the control chip defines a predetermined parameter of the battery; the state signals indicate whether the power supply provides power to the storage device, or a current parameter of the UPS is less than the predetermined parameter.

5. The storage control system of claim 4, wherein the predetermined parameter is one of an output current, an output voltage, and a capacity of the battery.

6. A storage control system, comprising:
a storage device having a write back process and a write through process for writing data into the storage device; and
an uninterruptible power supply (UPS) electrically connected to and communicating with the storage device, the UPS comprising a control chip and a battery, the control chip defining a predetermined parameter;
wherein the control chip sends a state signal to the storage device when a current parameter is less than the predetermined parameter; the storage device receives the state signal and changes from the write back process to the write through process for writing data into the storage device depending on the state signals.

7. The storage control system of claim 6, further comprising an external power supply electrically connected to the UPS, wherein the power supply provides power to the storage device and the UPS.

8. The storage control system of claim 7, wherein the external power supply provides power to the battery; the battery provides power to the storage device when the power supply is not providing power to the storage device.

9. The storage control system of claim 6, wherein the storage device comprises a monitoring module to receive the state signal and select the write through process or the write back process for writing the data to the storage device.

10. The storage control system of claim 6, wherein the predetermined parameter is one of an output current, an output voltage, a capacity of the battery.

11. A storage control system, comprising:
a storage device having a write back process and a write through process for writing data into the storage device;
an uninterruptible power supply (UPS) electrically connected to and communicating with the storage device, the UPS comprising a control chip; and
an external power supply electrically connected to the UPS and providing power to the storage device and the UPS;
wherein the control chip of the UPS sends a state signal to the storage device when the external power supply is providing power to the storage device and the UPS; the storage device receives the state signal and changes the write through process to the write back process for writing data into the storage device, depending on the state signals.

12. The storage control system of claim 11, wherein the storage device comprises a monitoring module to receive the state signal and change the write through process to the write back process for writing the data to the storage device.
